(19) United States
(12) Patent Application Publication
(10) Pub. No.: US 2003/0108482 A1
(43) Pub. Date: Jun. 12, 2003

(54) Method of producing salt

(76) Inventor: Byron James Deveson, Waramanga Australian Capital Territory (AU)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/312,431

(22) PCT Filed: Jun. 29, 2001
(86) PCT No.: PCT/AU01/00760

(30) Foreign Application Priority Data
Jul. 14, 2000 (AU) PQ 8816
Mar. 9, 2001 (AU) PR 3653

(51) Int. Cl. C01D 1/30

(52) U.S. Cl. 423/499.4; 23/303

(57) ABSTRACT

A method for the production of Na Cl or an aqueous Na Cl solution from sea-water or brine comprising contacting sea-water or brine with a waste product from the Bayer process used for the production of aluminium, known as red mud. In the production of Na Cl, red mud can be added to solar salt evaporation pools to remove impurities such as magnesium and calcium, resulting in the production of purified Na Cl crystals.

### FIELD OF INVENTION

The present invention relates to a method for producing an aqueous Na Cl solution or Na Cl from sea-water or brine using red mud or a red mud derivative to remove impurities and in particular to a method for producing Na Cl in solar evaporation ponds.

### BACKGROUND ART

Common salt (Na Cl), also known as halite, can be crystallized from solutions of sea-water, brine or other aqueous solutions containing salt. When sea-water is concentrated by solar evaporation and halite crystals recovered, certain impurities known as bittern remain in the crystals. Typically bittern comprises quantities of magnesium, calcium and heavy metals. Bittern, and especially magnesium salts, are deleterious impurities in halite crystals for many applications. Magnesium chloride is particularly undesirable in that it is deliquescent and prevents the salt from drying completely. To remove these impurities, solar salt has to be washed with an uncontaminated saturated brine solution. The washing procedure has attached operating costs, uses large volumes of fresh water which is often hard to source in localities which are suitable for solar salt production, and results in significant loss of salt. Large volumes of the residual bittern waste product are also produced and the disposal of this bittern is a major environmental problem for many solar salt plants.

Aqueous Na Cl solutions play an important part in many industrial processes. These industrial processes generally require aqueous Na Cl solutions of high purity, especially in respect of polyvalent metals such as, for example magnesium, calcium, aluminium, iron, lead, and zinc.

Red mud is produced in the Bayer process for the preparation of alumina from bauxite ores and it is generally considered to be a difficult and noxious waste product. Red mud is a complex mix of Fe and Al-oxyhydroxides and complex alumino-hydroxy carbonates which consists of predominantly fine particles with a high surface area/volume ratio and a high charge/mass ratio. Red mud is available in abundance in Australia as alumina refining is a major industry and it is likely to expand in the future. Approximately 10 million tonnes of red mud are produced each year in Australia and much of this is stored in ponds as highly alkaline waste material.

### SUMMARY OF INVENTION

According to one aspect the invention resides in a process for the production of Na Cl from sea-water or brine comprising crystallising Na Cl from sea water or brine, wherein the sea water or brine is previously contacted with red mud or a red mud derivative to reduce the levels of impurities.

In another aspect the invention resides broadly in a process for the production of an aqueous Na Cl solution, including contacting sea-water or brine with red mud or a red mud derivative in an amount and for a time sufficient to reduce the amount of impurities such as magnesium or calcium and separating the aqueous Na Cl solution from the red mud or red mud derivative.

Preferably red mud or a red mud derivative is added to sea-water or brine in the amount of 500 g/L or less.

Preferably the red mud or red mud derivative is kept in contact with the sea-water or brine for 4 weeks or less.

Preferably magnesium levels in the salt crystals is 500 μg/g or less, and more preferably 50 μg/g or less.

Preferably red mud is contacted with sea-water or brine to reduce the level of impurities. Alternatively, a red mud derivative is contacted with the sea-water or brine to reduce the level of impurities. The red mud derivative may be neutralized, purified, or acid or base activated red mud.

Preferably Na Cl is crystallised from sea-water by solar evaporation.

In a further preferred embodiment, isolated purified Na Cl crystals are further purified by washing.

When red mud is added to sea-water, natural brines, concentrated brine produced in the solar salt process and other aqueous solutions containing magnesium salts, the magnesium moiety is adsorbed by the red mud which can then be removed by any suitable method such as filtration or settling.

Red mud will also adsorb other impurities such as heavy metals and some organic materials, and it is considered that this enhances the usefulness of the process disclosed herein because these impurities are reduced in the salt or aqueous salt solution produced by this process.

In the production of salt, the red mud can either be added to the solar evaporation ponds and left in contact with the brine as it evaporates, or else the concentrated brine from the evaporation ponds can be contacted with red mud for a suitable period which is established by testing. Generally a contact period of about four weeks is required.

The quantity of red mud required for any desired reduction in impurity levels in the final halite crystals can be established beforehand by laboratory testing. In general it is considered that substantial removal of magnesium from the brines would be desirable and to achieve this the addition of about 250 grams of red mud per liter of concentrated brine is required.

The red mud can be recovered by any suitable method such as filtration, and the red mud can then be used in other applications such as the remediation of acid soils and the removal of heavy metals and other pollutants from acid mine drainage.

An alternative to the use of red mud, is the use of a red mud derivative in the process of the invention. Red mud derivatives may include for instance, red mud that has undergone neutralization, purification, acid or base activation, further refinement or processing. Red mud derivatives would share in common with red mud the ability to absorb impurities from sea-water or brine such as magnesium, calcium, aluminium, copper, iron, manganese, nickel, strontium, zinc, lead, arsenate or phosphate.

### BEST MODE

The invention will now be described with reference to examples for illustrative purposes. In the examples BLD represents a concentration below the level of detection of the assay used. The lowest detectable level is indicated in numerals after the letters BLD.

### EXAMPLE 1

Dried red mud was added to sea-water in an amount of 40 grams of dried red mud per one litre of sea-water and the mixture was left for four weeks with occasional stirring. After four weeks the mixture was filtered and content of various substances remaining in the sea-water was determined by chemical analysis. These same tests had been performed on the sea-water before the red mud was added.

Results:

| | Concentration in sea water | | Concentration in sea water | |
|---|---|---|---|---|
| Substance: | before treatment: | | after treatment: | |
| Aluminium | 160 | μg/L | 12 | μg/L |
| Calcium | 420 | mg/L | 0.5 | mg/L |
| Copper | 5.5 | μg/L | BLD 0.2 | μg/L |
| Iron | 17 | μg/L | BLD 0.15 | μg/L |
| Magnesium | 1,340 | mg/L | 2.5 | mg/L |
| Manganese | 3.5 | μg/L | BLD 0.1 | μg/L |
| Nickel | 0.4 | μg/L | BLD 0.15 | μg/L |
| Strontium | 11.5 | mg/L | BLD 0.2 | μg/L |
| Zinc | 16 | μg/L | BLD 0.007 | μg/L |
| Arsenate | 10 | μg/L | BLD 0.1 | μg/L |
| Phosphate | 26 | μg/L | BLD 1.5 | μg/L |

### EXAMPLE 2

Seawater was concentrated by solar evaporation until halite crystals just started to crystallize from the solution. This occurred at a concentration factor of about ten. Then dried red mud at a concentration of 240 grams per litre of concentrated brine was added. The mixture was then left for four weeks with occasional stirring. After four weeks the red mud was filtered from the brine and the brine was chemically analysed.

Results:

| | Concentration in sea water | | Concentration in brine | |
|---|---|---|---|---|
| Substance: | before treatment: | | after treatment: | |
| Aluminium | 160 | μg/L | BLD 8 | μg/L |
| Calcium | 420 | mg/L | 12.3 | mg/L |
| Copper | 5.5 | μg/L | BLD 0.2 | μg/L |
| Iron | 17 | μg/L | BLD 0.15 | μg/L |
| Magnesium | 1,340 | mg/L | 14.0 | mg/L |
| Manganese | 3.5 | μg/L | BLD 0.1 | μg/L |
| Nickel | 0.4 | μg/L | BLD 0.15 | μg/L |
| Strontium | 11.5 | mg/L | BLD 0.2 | μg/L |
| Zinc | 16 | μg/L | BLD 0.007 | μg/L |
| Arsenate | 10 | μg/L | BLD 0.1 | μg/L |
| Phosphate | 26 | μg/L | BLD 1.5 | μg/L |

### EXAMPLE 3

Seawater used in the previous examples was concentrated by solar evaporation and halite crystals were recovered. These crystals were not washed in any way. A sample of the concentrated and treated brine produced in example 2 was also allowed to crystallize and the halite crystals were washed with a saturated solution of analytical grade sodium chloride to model the washing process that is used in commercial solar salt plants. The halite crystals produced in both cases were dried and then chemically analysed.

Results:

| | Concentration in halite | | Concentration in halite | |
|---|---|---|---|---|
| Substance: | no treatment: | | with treatment: | |
| Aluminium | 0.10 | μg/g | BLD 0.04 | μg/g |
| Calcium | 2270 | μg/g | 18.6 | μg/g |
| Copper | 0.32 | μg/g | BLD 0.02 | μg/g |
| Iron | 2.7 | μg/g | BLD 0.05 | μg/g |
| Magnesium | 1560 | μg/g | 24.4 | μg/g |
| Manganese | 0.07 | μg/g | BLD 0.04 | μg/g |
| Nickel | BLD 0.06 | μg/g | BLD 0.06 | μg/g |
| Strontium | 80 | μg/g | 4.5 | μg/g |
| Zinc | 18 | μg/g | BLD 0.015 | μg/g |
| Arsenate | 0.4 | μg/g | BLD 0.02 | μg/l |
| Phosphate | 0.35 | μg/g | BLD 0.05 | μg/g |

It will of course be realised that whilst the above has been given by way of illustrative examples of this invention, all such and other modifications and variations hereto, as would be apparent to persons skilled in the art, are deemed to fall within the broad scope and ambit of this invention as is herein set forth.

1. A process for the production of Na Cl from sea-water or brine comprising crystallizing Na Cl from sea-water or brine, wherein the sea-water or brine is previously contacted with red mud or a red mud derivative to reduce the levels of impurities.

2. The process of claim 1, wherein red mud or a red mud derivative is added to sea-water or brine in the amount of 500 g/L or less.

3. The process of claim 1 or claim 2, wherein the red mud or red mud derivative is kept in contact with the sea-water or brine for 4 weeks or less.

4. The process of any one of claims 1 to 3, wherein magnesium levels in the purified Na Cl crystals is 500 μg/g or less.

5. The process of any one of claims 1 to 4, wherein magnesium levels in the purified Na Cl crystals is 50 μg/g or less.

6. The process of any one of claims 1 to 5, wherein Na Cl is crystallized from sea-water by solar evaporation.

7. The process of any one of claims 1 to 6, wherein the crystallized Na Cl is further purified by washing.

8. The process of any one of claims 1 to 7, wherein red mud is contacted with sea-water or brine to reduce the level of impurities.

9. The process of any one of claims 1 to 7, wherein a red mud derivative is contacted with the sea-water or brine to reduce the level of impurities.

10. The process of claim 9, wherein the red mud derivative is neutralized red mud.

11. The process of claim 9, wherein the red mud derivative is purified red mud.

12. The process of claim 9, wherein the red mud derivative is acid or base activated red mud.

13. A process for the production of Na Cl from sea-water or brine comprising:
employing red mud or a red mud derivative to substantially strip at least magnesium from the sea-water or brine; and
crystallizing Na Cl from the sea-water or brine.

14. The process of claim 13, wherein red mud or a red mud derivative is added to sea-water or brine in the amount of 500 g/L or less.

15. The process of claim 13 or claim 14 wherein the red mud or red mud derivative is kept in contact with the sea-water or brine for 4 weeks or less.

16. The process of any one of claims 13 to 15, wherein magnesium levels in the purified Na Cl crystals is 500 μg/g or less.

17. The process of any one of claims 13 to 16, wherein magnesium levels in the purified Na Cl crystals is 50 μg/g or less.

18. The process of any one of claims 13 to 17, wherein Na Cl is crystallized from sea-water by solar evaporation.

19. The process of any one of claims 13 to 18, wherein the crystallized Na Cl is further purified by washing.

20. The process of any one of claims 13 to 19, wherein red mud is contacted with sea-water or brine.

21. The process of any one of claims 13 to 19, wherein a red mud derivative is contacted with the sea-water or brine.

22. The process of claim 21, wherein the red mud derivative is neutralized red mud.

23. The process of claim 21, wherein the red mud derivative is purified red mud.

24. The process of claim 21, wherein the red mud derivative is acid or base activated red mud.

25. Na Cl produced by the process of any one of the preceding claims.

26. A process for the production of an aqueous Na Cl solution, including contacting sea-water or brine with red mud or a red mud derivative in an amount and for a time sufficient to reduce the amount of impurities such as magnesium or calcium and separating the aqueous Na Cl solution from the red mud or red mud derivative.

27. The process of claim 26, wherein red mud or a red mud derivative is added to sea-water or brine in the amount of 500 g/L or less.

28. The process of claim 26 or claim 27, wherein the red mud or red mud derivative is kept in contact with the sea-water or brine for 4 weeks or less.

29. The process of any one of claims 26 to 28, wherein red mud is contacted with sea-water or brine.

30. The process of any one of claims 26 to 28, wherein a red mud derivative is contacted with the sea-water or brine.

31. The process of claim 30, wherein the red mud derivative is neutralized red mud.

32. The process of claim 32, wherein the red mud derivative is purified red mud.

33. The process of claim 32, wherein the red mud derivative is acid or base activated red mud.

34. An aqueous Na Cl solution produced by the process of any one of claims 26 to 33.

35. Na Cl produced from the aqueous Na Cl solution of claim 34.

36. A process for the production of Na Cl from sea-water by solar evaporation, wherein seawater is collected in a solar salt evaporation pond, red mud is added to the solar salt evaporation pond in quantities and for a time sufficient to reduce the levels of impurities by precipitation, and Na Cl is crystallized from the purified sea-water.

37. A process of producing an aqueous Na Cl solution or a process of producing Na Cl substantially as herein described.
